(19) United States
(12) Patent Application Publication
(10) Pub. No.: US 2005/0270735 A1
(43) Pub. Date: Dec. 8, 2005

(54) Remote control holding unit

(76) Inventor: Che-Chih Chen, Taipei County (TW)

Correspondence Address: Whole Year Plastics Co., Ltd., P.O. Box No. 6-57, Junghe, Taipei, 235, TW

(21) Appl. No.: 10/861,424

(22) Filed: Jun. 7, 2004

(51) Int. Cl. G06F 1/16

(52) U.S. Cl. 361/683

(57) ABSTRACT

A remote control holding unit, includes a type of remote control for a controlled laptop computer, characterized as: a remote control unit stored in a securing frame that corresponds to a PCMCIA inserting slot of a laptop computer, allowing the remote control unit to be stored when not in use. The remote control is carried conveniently in the securing frame, in addition, allowing a lighting device or a calculator to be stored. The remote control unit can be separated from the securing frame to achieve more sufficient application.

### BACKGROUND OF THE INVENTION

a) Field of the Invention

The present invention relates to a remote control holding unit, particularly to be used in controlling a laptop computer, to achieve better storing purposes.

b) Description of the Prior Art

This is an era of information and speed, to grasp information is to grasp opportunity, therefore a easily carried and stored laptop computer has become a compulsory tool for the businessman; the laptop has powerful processing functions which an user can utilize to create and complete documents and graphs and save them in a hard disk or CD, which could be played back later at a client's office through a projector, creating good impressions and increasing chances of success.

A conventional laptop computer does not have a remote control installed; therefore while explaining over a projector, often have to operate the laptop as well, moreover making way between the screen and the laptop.

Lecturing over a projector whilst operating a laptop was inconvenient, until the laptop remote control appeared; regarding the prior art, the remote control for the laptop computer consists of a control box 6a and a remote control unit 1a (Refer to FIG. 4). Furthermore, before using the remote control, the control box 6a must be electronically connected to the laptop, therefore extremely inconvenient in use and in storage.

Moreover, the remote control unit of the conventional laptop computer is made to allow insertion with the standard PCMCIA slot; therefore the design is different to the common remote control in size, causing inconvenience when held and in use.

### SUMMARY OF THE INVENTION

A primary objective of the present invention is to provide a remote control used for a laptop computer, to enable easier storage.

The present invention consists mainly of a remote control unit and a securing frame, the feature of the invention is that the remote control is stored within the securing frame, and the securing frame is inserted into the PCMCIA slot of a laptop computer.

Moreover a lighting unit or a calculator can be stored in the securing frame when the securing frame and the remote control unit is separated.

To enable a further understanding of the said objectives and the technological methods of the invention herein, the brief description of the drawings below is followed by the detailed description of the preferred embodiments.

### BRIEF DESCRIPTION OF THE DRAWINGS

FIG.1 shows an exploded view according to the present invention.

FIG.2 shows a perspective schematic view according to the present invention.

FIG.3 shows an exploded view of the preferred embodiment according to the present invention.

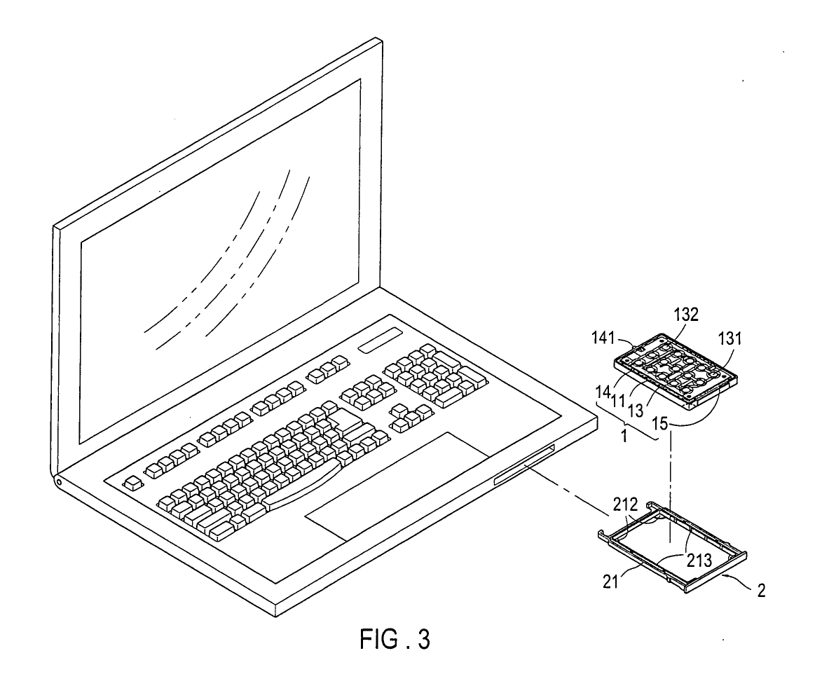

FIG.4 shows an exploded view of the conventional laptop remote control device.

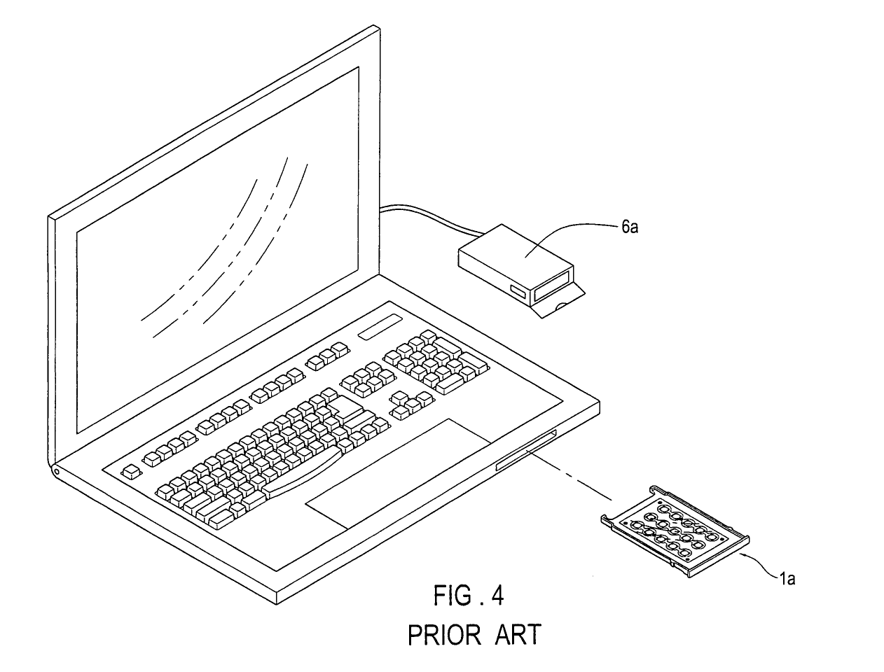

### DETAILED DESCRIPTION OF THE PREFERRED EMBODIMENTS

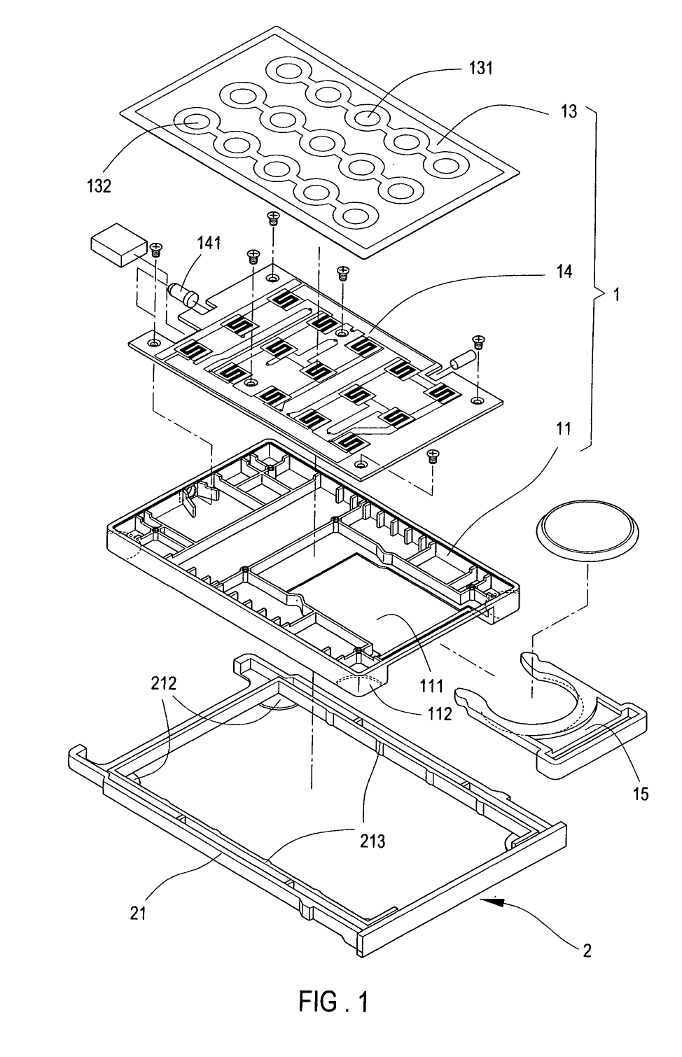

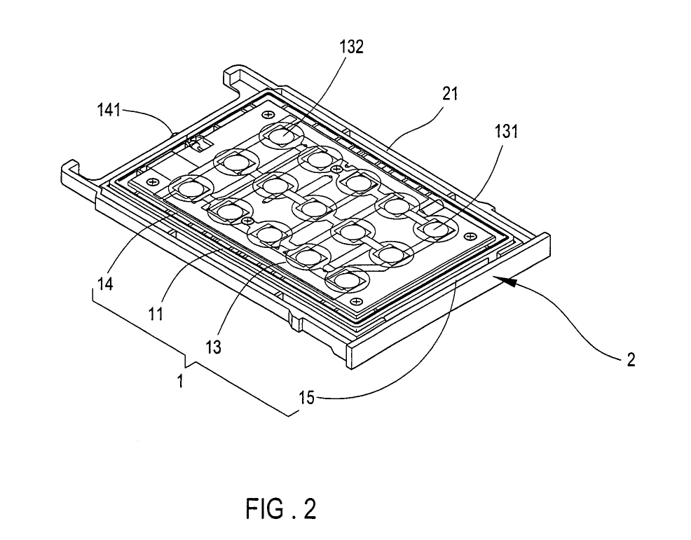

As shown in FIG. 1 and 2, the present invention refers to a remote control used in a controlled laptop computer, consisting of a remote control unit 1 a securing frame 2, the feature of the invention is: the outer circumference of the securing frame matches the PCMCIA inserting slot, a long frame unit 21 is established on an inner side of the securing frame 2, a fan shaped member 212 is formed on four lower corners of a frame unit 21, a plurality of protruding portion are formed on an inner rim of the frame unit 21.

The remote control unit 1 mainly consists of a lower casing 11, the outer side of the lower casing 11 corresponds to the inner side of the frame unit 21, fan shape member 212 are formed on the four lower corners of the lower casing 11 that corresponds to the fan shape grooves 112, a face panel 13 is placed above the lower casing 11, a circuit board 14 is configured in between the lower casing 11 and the face panel 13, a battery chamber 111 is equipped on a rear end of the lower casing 11, the battery chamber 111 has a battery clip 15 assembled therein.

A plurality of numerical buttons 131 and functional buttons 132 is formed on the face panel 13.

An infrared output device 141 is disposed in at the front of a circuit board 14 after assembling into the lower casing 11.

According to the aforesaid structure, the remote control unit 1 uses infrared to control the laptop computer, moreover, the remote control unit 1 is placed into the frame unit 21, the fan shaped groove 112 of the lower casing 11 assembles with the fan shaped member 212 on the inner side of the frame unit 21, and the protruding portions 213 formed on the inner rim of the frame unit 21 is fastened tightly with the outer side of the lower casing 11, allowing the remote control unit 1 to hold firmly in the frame unit 21, therefore a remote control holding unit is configured.

Furthermore, when the remote controlled laptop function is needed, the control unit can be used by sliding out a securing frame 2 from the PCMCIA slot of the laptop, whereby taking out the remote control unit 1 from the frame unit 21 of the securing frame 2.

As the design allows the securing frame 2 and the remote control unit 1 to be separated when in use, it provides better handling of the remote control unit 1 compared to the prior art, moreover easier to function.

Another embodiment of the present invention, a lighting device can be placed within the securing frame 2, or a calculator placed above the frame unit 21; moreover the securing frame 2 is inserted in the PCMCIA slot of the laptop, resulting in easier and more convenient storage.

It is of course to be understood that the embodiments described herein is merely illustrative of the principles of the invention and that a wide variety of modifications thereto may be effected by persons skilled in the art without departing from the spirit and scope of the invention as set forth in the following claims.

1. A remote control holding unit for remote controlling a laptop computer, comprising a remote control unit and a securing frame,
wherein, the outer circumference matches a PCMCIA inserting slot, a long frame unit is established on an inner side of the securing frame, a fan shaped member is formed on four lower corners of a frame unit, a plurality of protruding portion are formed on an inner rim of the frame unit;
the remote control unit comprises of a lower casing, the outer side of the lower casing corresponds to the inner side of the frame unit, the fan shape member are formed on the four lower corners of the lower casing thereby corresponds to the fan shape grooves, a face panel is placed above the lower casing whereas a circuit board is configured in between and a battery clip is assembled on a rear end thereof.

2. The remote control holding unit as recited in claim 1, wherein, the face panel forms a plurality of numerical buttons and a plurality of functional buttons.

3. The remote control holding unit as recited in claim 1, wherein, a lighting device is stored in the remote control unit.

4. The remote control holding unit as recited in claim 1, wherein, a calculator is placed above the frame unit.

5. The remote control holding unit as recited in claim 1, wherein, an infrared output device is disposed in at the front of the circuit board.
